(19) United States
(12) Patent Application Publication
(10) Pub. No.: US 2017/0140484 A1
(43) Pub. Date: May 18, 2017

(54) VIRTUAL OR AUGMENTED REALITY CUSTOMIZATION SYSTEM AND METHOD

(71) Applicant: Lennar Pacific Properties Management, Inc., Miami, FL (US)

(72) Inventors: Laura L. Lete, St. Augustine, FL (US); Stephen R. Smith, Miami, FL (US); Christopher D. Oakes, Miami, FL (US); Pablo R. Alfonso, Miami Lakes, FL (US)

(21) Appl. No.: 15/356,312

(22) Filed: Nov. 18, 2016

Related U.S. Application Data
(60) Provisional application No. 62/257,069, filed on Nov. 18, 2015.

(51) Int. Cl. G06Q 50/16; G06F 3/16; G06T 19/00

(52) U.S. Cl. CPC G06Q 50/16; G06T 19/006; G06F 3/167

(57) ABSTRACT

A software application for execution upon an electronic device (e.g., a smartphone, tablet, headgear, wearable, etc.) for a potential consumer of real estate. The software application may provide a completely virtual setting that is customizable (e.g., via a user interface or voice recognition) by the user. The software application may provide an augmented setting through a display of the electronic device that draws over or otherwise modifies portions or areas of a physical setting that is being viewed upon a display of the electronic device. Users can interact with the software via voice commands, an input device, such as a mouse, keyboard, and/or other manipulatable pad, in order to choose or select desired customizations.

### CROSS REFERENCE TO RELATED APPLICATIONS

This application claims the benefit of U.S. Provisional Patent Application Ser. No. 62/257,069, filed on Nov. 18, 2015, entitled “VIRTUAL OR AUGMENTED REALITY CUSTOMIZATION SYSTEM AND METHOD,” which is hereby incorporated by reference in its entirety.

### BACKGROUND

1. Field of the Invention

The present invention relates to a method and apparatus for allowing a user to customize a real estate property or other location. More particularly, the present invention relates to a mobile or other software application (either using virtual reality and/or augmented reality) to customize the look of a location or property based upon user input.

2. Description of the Related Art

The home search or real estate market is a large business both in the United States and Worldwide, linking potential customers of a large variety of real estate properties (e.g., single family homes, apartment homes, condominiums, land, business leases, etc.) with a vast array of information about such properties. Typically, a potential customer has one or more preferred looks and/or styles that they desire more than others when shopping for a potential real estate property for lease and/or for purchase. In addition to looks and/or styles, other aspects (floor layout, number of bedrooms, etc.) may also be of importance to a potential customer while they engage in the shopping experience.

Conventionally, particularly in properties that are being built with multiple unit types (e.g., an apartment or condominium complex with multiple room options, such as one bedroom units, two bedroom units, etc.), one or more showrooms or showcase units are constructed so that a potential customer can walk around inside and get a feel for the property prior to purchase. These showrooms or showcase units may be furnished with a variety of decorations, furniture, appliances, and/or other furnishings so that a potential customer may more readily get a feel for what it would be like to live in the unit. Unfortunately, as different customers have different preferences in both furnishings and/or unit types, it is often not possible to show an ideal unit with ideal furnishings to each customer. As such, many customers may not be satisfied with the unit as shown to them and must still use their imagination to determine whether the property would be a good match for their tastes.

Typically, to help accommodate this variety of customer tastes, multiple different showrooms or showcase units may be constructed and made available for customer walk through. However, this can be expensive, in both manufacturing cost and in lost revenue cost, since these showrooms must remain empty for showings and take up land that might otherwise be used for a property that can be leased or sold. Moreover, a customer may be required to drive or otherwise travel to multiple geographic locations in order to walk through these showrooms (e.g., showrooms located at different apartment complexes that may be of interest to the customer). This travel is inefficient for customers and can make the process of shopping more frustrating and time-consuming.

Thus, there is a need for an improved system and/or method for allowing customers to search and/or otherwise view properties that are available for lease or purchase that lessen one or more of the above-described problems. Ideally, such a system and/or method would allow a customer to customize a given property (or multiple properties) efficiently and to a greater degree than has been conventionally performed.

### SUMMARY

The present invention is related to a method and/or application and/or system for allowing a user to view and/or customize real estate or other properties or locations. A variety of possible embodiments, utilizing all or some of the features discussed and/or illustrated throughout this application may provide a system, apparatus, and/or method for virtually and/or partially virtually (e.g., via augmented reality) touring a property (e.g., a home and/or community), such as via interaction with an avatar, visiting one or more rooms and/or community features or amenities, traveling outside of the boundaries of a home to see the lot and/or elevation and/or other geographic characteristics for placement of the home and/or to visually examine the surroundings (e.g., looking down or across the street), etc. As discussed throughout, any of a variety of possible user inputs may be received to facilitate the touring of the property, such as voice commands (e.g., “Show me the master bedroom again,” “Can I see the backyard,” etc.), motion-based commands, and/or other interaction with a user-interface device, such as a gamepad, keyboard, joystick, mouse, etc.

In one embodiment, a method of providing a customizable virtual setting for a potential customer of real estate may include the steps of providing a software application configured to be executed by a processor, providing a database containing information corresponding to a plurality of customizations for selection by the customer, displaying to the customer the customizable virtual setting via a screen, determining, using the processor, a desired customization by the customer based upon at least one of the plurality of customizations, and displaying the desired customization in the customizable virtual setting based on at least some of the information stored in the database.

In another embodiment, a method of providing a customizable augmented setting for a potential customer of real estate may include the steps of providing a software application configured to be executed by a processor of a mobile device, providing a database containing information corresponding to a plurality of customizations for selection by the customer, the database in communication with the processor, displaying to the customer the customizable augmented setting via a screen of the mobile device using a camera of the mobile device, determining, using the processor, a desired customization by the customer based upon at least one of the plurality of customizations, and displaying the desired customization in the customizable augmented setting via the screen of the mobile device based on at least some of the information stored in the database and image recognition of at least a portion of the customizable augmented setting displayed via the screen of the mobile device.

### BRIEF DESCRIPTION OF THE DRAWINGS

The features, objects, and advantages of the present invention will become more apparent from the detailed description set forth below when taken in conjunction with the drawings, wherein:

FIG. 1 shows a customizable virtual reality real estate property viewing system according to one embodiment of the present invention;

FIG. 2 shows a customizable virtual real estate property system according to one embodiment of the present invention;

FIG. 3 shows a flowchart for implementing a customizable virtual reality real estate property viewing system according to one embodiment of the present invention;

FIG. 4 shows a flowchart for implementing a customizable augmented reality real estate property viewing system according to one embodiment of the present invention; and

FIG. 5 shows a block diagram of a system implementing a real estate search software application according to one embodiment of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

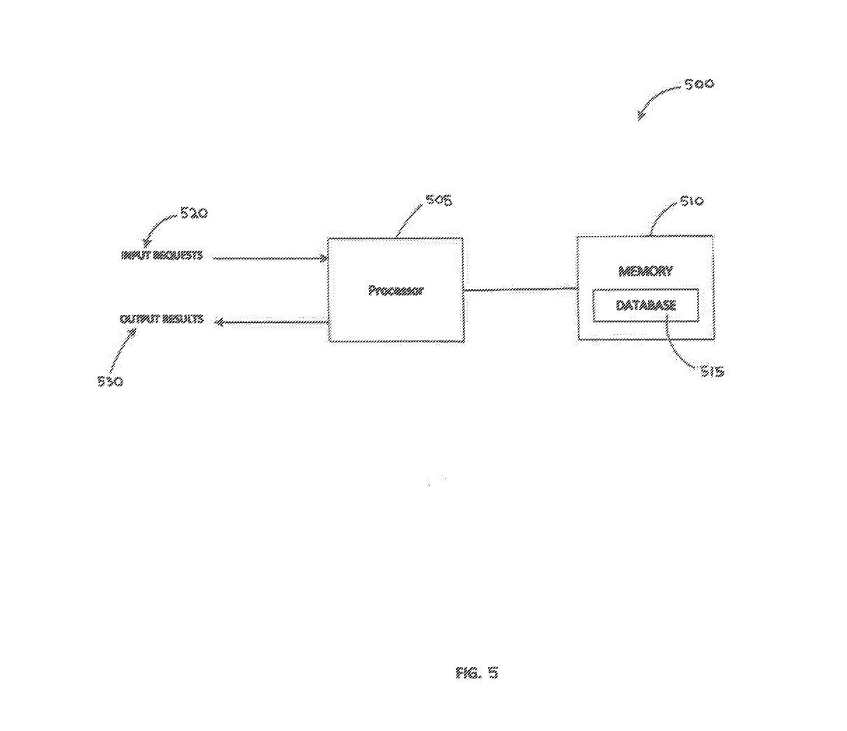

FIG. 5 illustrates a block diagram of a system 500 that may implement a customizable home or real estate viewing system and/or software application. For example, the system and/or software application may include features that are the same as or similar to those discussed throughout. The system 500 includes a processor 505 connected with a memory 510, the memory 510 configured to store data. The processor 505 is configured to interface or otherwise communicate with the memory 510, for example, via electrical signals propagated along a conductive trace or wire. In an alternative embodiment, the processor 505 may interface with the memory 510 via a wireless connection. In one embodiment, the memory 510 may include a database 515, a plurality of data or entries capable of being stored in the database 515 of the memory 510. For example, as discussed in greater detail herein, the memory 510 and/or the database 515 may store information about real estate properties that may be accessed and/or retrieved and/or sent to a user based upon user requests and/or criteria.

As discussed in greater detail herein, the processor 505 may be tasked with executing software or other logical instructions in order for the service request application to function as desired. Input requests 520 may be received by the processor 505 (e.g., via signals transmitted from a user at a remote system or device 521, such as a handheld device like a smartphone or tablet, to the processor 505 via a network or Internet connection). In an alternative embodiment, the input requests 520 may be received by the processor 505 via a user input device 521 that is not at a geographically remote location (e.g., via a connected keyboard, mouse, etc. at a local computer terminal). After performing tasks or instructions based upon the user input requests 520, for example, looking up information or data stored in the memory 510, the processor 505 may output results 530 (e.g., customizations, furniture choices, etc.) back to the user that are based upon the input requests 520. In an alternative embodiment, any of a variety of systems capable of receiving input data, accessing stored data, processing software instructions, and/or transmitting output data may be utilized.

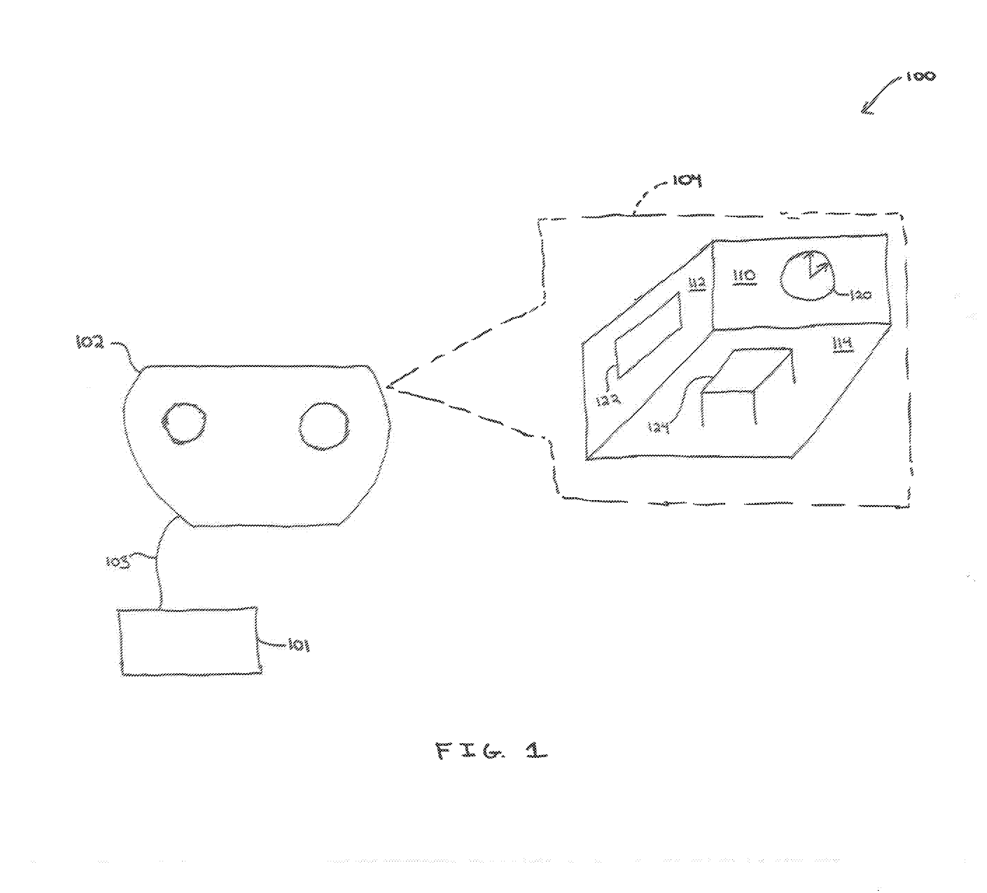

FIG. 1 shows a customizable virtual reality real estate property viewing system 100. One or more aspects or features of the system may utilize hardware, software, and/or other features or operational capabilities the same as or similar to discussed above for FIG. 5. As illustrated, hardware and software may cooperate with one another in order to allow a user to view one or more virtual properties, with a variety of possible customizations, as discussed in greater detail herein. In this fashion, one or more of the conventional issues with viewing a showcase property, described above, such as efficiency, prohibitive cost, and/or lack of customer-specific customizations may be addressed.

Headgear 102 or other hardware capable of providing a displayed virtual setting for a real estate property (or other location) may be provided and connected 103 with a system 101. The connection 103 may be hardwired and/or wireless in various embodiments. For example, one or more headgear 102 may be kept at a real estate office (e.g., a leasing office) that can be provided to potential customers that enter the office in order to virtually view available real estate, in addition to or in alternative to physically taking the potential customer to a physically constructed showroom or showcase property. In an alternative embodiment, the headgear 102 may be provided by the customer themselves (e.g., the customer may use headgear 102 or other hardware that they own or that is present within their own home and connect 103 to the system 101 remotely, such as over an Internet connection). In such an embodiment, a potential customer may shop and/or view potential real estate within the privacy of their home or other location, without necessitating any travel to a leasing office or other remote location. The system 101 may have stored any of a variety of data in a memory that allows the creation, customizing, and/or showing of a virtual setting to the potential customer via the headgear 102 (e.g., the same as or similar to the previous discussion for FIG. 5).

The headgear may be any of a variety of hardware that interacts with the potential customer's or user's eyes in order to display a virtual property to the user. Once in use by the user, the headgear 102 (via the information or data provided by the system 101) may display a setting 104 to the user. In a preferred embodiment, the user may be able to move around the setting. In other embodiments, the user may only be able to look around, but not move within the setting 104. In still another embodiment, the user may only be provided with a static image that makes up the setting 104.

The setting 104 may be a room or other area for a particular piece of real estate. For example, as illustrated, the setting 104 may include at least a first wall 110, a second wall 112, and a floor 114. Various furnishings may be provided on one or more of the first wall 110, the second wall 112, and/or the floor 114. As shown, a clock furnishing 120 is disposed upon the first wall 110. Likewise, as shown, a picture furnishing 122 is disposed upon the second wall 112. Moreover, a table furnishing 124 is disposed upon the floor 114. In an alternative embodiment, any of a variety of furnishings, multiple furnishings, or no furnishings may be provided on or within the displayed setting 104. In addition or in alternative to furnishings, characteristics for the setting 104 may also be shown. For example, the first wall 110 may have a particular wallpaper pattern, finish, texture, material, and/or color, the second wall 112 may have a particular wallpaper pattern, finish, texture, material, and/or color (either the same as or different from the first wall 110), and/or the floor 114 may have a particular flooring type (e.g., tile, wood, laminate, etc.), finish, texture, material, and/or color.

Any or all of the above described furnishings and/or characteristics may be customized by a user. Such customization may be performed by or for the user while the user in viewing the setting 104 and/or may be setup prior to the user viewing the setting 104. In this fashion, the setting 104 showcasing the viewed real estate property or other location may be particularly customized for each individual user that views the property without the need to physically manufacture each customized and/or exact set of user preferences, saving cost and time. Furnishings may be switched, interchanged, substituted, etc. to any desired location, removed entirely, or replaced with other furnishings. Similarly, wall colors, patterns, and/or other characteristics may be switched, interchanged, substituted, etc. to any desire by the user. Likewise, floor types, colors, and/or other characteristics may similarly be switched, interchanged, substituted, etc. to any desire by the user. Other aspects, ceiling finishes or looks, materials used (e.g., types of countertops like granite, etc.) lighting (e.g., color, mood lighting, types of fixtures, etc.), or other features may all be customized by or for the user.

In certain embodiments, structural changes may be performed based upon user input and/or setup parameters for the user, the same as or similar to previous discussions, in addition to or alternatively to the above described features. For example, instead of or in addition to modifying furnishings of a unit, a user may be permitted to choose options that allow customization of the floor plan and/or other structural elements for a given property (e.g., moving, adding, and/or deleting a wall, door, window, etc.). Such structural changes and/or furnishing modifications may be displayed to the user with and/or without associated pricing information. Other information (e.g., parts lists/costs, equipment lists/costs, labor costs, etc.) may be provided for corresponding customizations in certain embodiments.

In one embodiment, such customizations are available within the system 101 for the user or other operator to choose amongst for the setting 104. For example, a user interface may be overlaid for viewing by the user over the setting 104 via the headgear 102. By interfacing or manipulating this user interface, the user may input into the system 101 whether they desire a particular customization and what such customization may be. In one embodiment, the user interface may include drop-down boxes, icons, or any other type of element that a user can click or otherwise interface with via a pointing device or other manipulation that is manipulated by one of the users hands, fingers, eye movements, motion, speech, or other selection possibility (e.g., a mouse, a motion-controlled gamepad or other controller, etc.). In other embodiments, selection of one or more options may be performed via interactions other than via the headgear 102 or in combination with selections made via the headgear 102 (e.g., one or more options or customizations may be made using a conventional screen connected with the system 101, such customizations then displayed via the headgear 102). Thus, certain embodiments may utilize the headgear 102 and one or more other display devices, such as conventional monitors, for displaying desired user options or customizations.

In other embodiments, the user interface may be voice-recognition based. For example, in one embodiment, a virtual agent or other avatar may speak to the user and ask the user questions and/or suggestions on how the setting 104 may be customized (e.g., “do you like this color for the walls or would you like to change to a different color or wallpaper?”). In this fashion, the virtual agent may prompt the user to answer questions regarding the unit in order to customize the unit. Alternatively, or in addition, the user may speak desired customizations without prompting by any virtual agent (e.g., “I would like to change the lighting fixture at this location.”). The system 101 may recognize the user's voice command and either perform a corresponding action to customize the unit in the desired way and/or ask the user for clarification or more details regarding the request. For example, if there is an ambiguity in the user's command, the system 101 may prompt the user for clarification. In another example, if the user states they wish to change a desired characteristic and/or furnishing of the setting 104, the system 101 may present, either visually or audibly, the user with possibilities that the user may subsequently choose amongst.

In certain embodiments, the voice recognition and/or other user interface elements may allow a user to quickly travel from one place within a unit to another or across multiple units. For example, if a user is most interested in what the master bedroom looks like for homes they are shopping for, the user may state (either independently, or in response to a prompt from the system, such as via a virtual agent) that they wish to see the master bedroom. The system 101 may then load the master bedroom for display to the user via the headgear 102 without requiring the user to move or travel through the unit to reach such area. In certain embodiments, the user's most desired room or area may be the first room or area that is loaded for display by the headgear 102 to the user. In certain embodiments, the user may be able to immediately switch among different units or areas (e.g., load a completely different apartment home for viewing from the one they were presently within), travel outside the unit (e.g., see a surrounding neighborhood for the home), and/or any of a variety of travel options, either upon their own movement using a user interface or control element, via unprompted voice commands or other user interface manipulation, and/or upon responding to prompted questions provided by the system 101. In certain embodiments, the user may be able to tour any of a variety of geographically settings around the home and/or those areas that are not in immediate vicinity of the home (e.g., users can tour any of a local property, a local community of a particular property, and/or other communities—either locally or in other cities or geographic locations).

The setting 104 viewed via the headgear may be a fully three-dimensional space that allows for movement of the user therein via some form of user input. For example, in certain embodiments, the user's physical position while wearing the headgear 102 may be tracked such that if the user steps or leans forward, a corresponding movement is portrayed via the headgear 102 to the user. In certain embodiments, the user may be provided with some form of control element (e.g., a gamepad, mouse, etc.) that the user can manipulate in order to facilitate movement within the three-dimensional space of the setting 104. In certain embodiments, this control element may be used to facilitate interaction either with the setting 104 (e.g., opening of cabinets, drawings, turning on of faucets, etc.) and/or a user interface displayed by the headgear 102 and overlaid on top of the setting 104, for example, as described above.

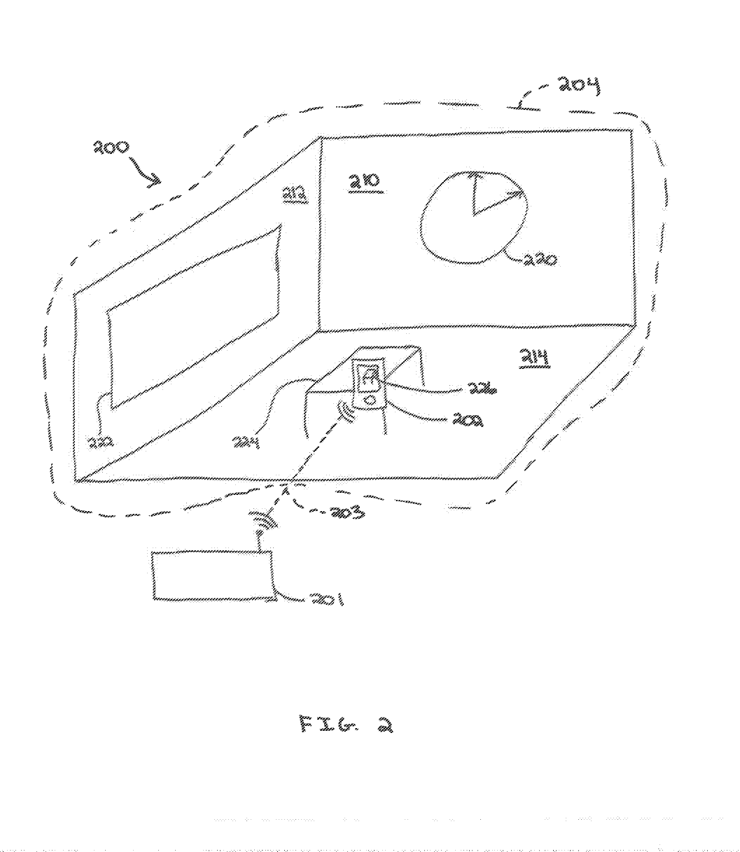

FIG. 2 shows another embodiment of the present invention that implements an augmented reality customizable real estate property system 200. While certain embodiments of the system 100 described for FIG. 1 include creation of an entirely virtual setting that a user can examine and/or customize, the embodiment shown for the system 200 of FIG. 2 utilizes both physical construction elements and virtual elements to customize a user's experience when viewing a real estate property or other location, as described in greater detail herein. Certain features and/or operation of the system 200 may be the same as or similar to those previously described.

As illustrated, a setting 204 (e.g., a home or portion of a home, building, or any other geographic location or setting) may be established for a user to travel in or near for viewing. In certain embodiments, this setting 204 may be a manufactured showroom or other demonstrative unit, such as an apartment complex, condominium unit, etc. that can be shown to a user and/or where the user is permitted to walk around the setting 204 to get a feel for its layout and/or a sense of how it would feel to live or reside therein. As previously mentioned, problems with customization may occur because a user may want particular furnishings, features, or other characteristics in a desired unit and it may not be feasible or cost-effective to manufacture or create a separate showroom that physically matched to a particular user's tastes.

For example, as shown, the setting 204 may include a first wall 210 with a first furnishing 220 (e.g., a clock) disposed thereon, a second wall 212 with a second furnishing 222 (e.g., a painting) disposed thereon, and a flooring 214 (e.g., constructed of any of a variety of materials, such as tile, wood, carpet, laminate, etc.). A first item of furniture 224 (e.g., a table) may be disposed within the setting 204. Conventionally, a user may only be able to witness such items without any means of customization and would be required to use their own imagination in order to envision that the setting 204 might look like with alternative furnishings.

However, in one embodiment of the present invention, as shown, the user may be permitted to view customizations upon an electronic device 202 (e.g., a mobile device such as a smart phone, tablet, wearable, etc.) that is also within the setting 204 by choosing desired customizations and viewing the setting 204 or portions of the setting 204 via the electronic device, as discussed in greater detail herein. The electronic device 202 contains a display 226 that is configured to display at least a portion of the setting 204, for example, based upon a position or orientation of the electronic device 202. In one embodiment, the electronic device 202 may contain a camera that the user can point at particular areas of the setting 204 and those areas of the setting 204 will correspondingly show up on the display 226 of the electronic device 202.

As illustrated, a user can position the electronic device 202 such that a camera on the electronic device 202 is pointed towards the item of furniture 224. This may cause a real time (or substantially real-time) image of the item of furniture 224 to be displayed upon the display 226 of the electronic device 202. This functionality allows a user to choose or otherwise indicate if and/or what customizations they would like to see for the setting 204. For example, if the user indicates that they would prefer for a glass table to be included in the setting 204 in place of the item of furniture 224, such a desired choice may be communicated by the user and the display 226 updated and/or modified in accordance, as discussed in greater detail below. In an alternative embodiment, non-real time (e.g., static photographs or videos) may be recorded and customized as described above for viewing at a subsequent time.

In one embodiment, a system or component 201 may be in communication 203 (e.g., wireless communication) with the electronic device 202. The system or component 201 may be located remotely from the setting 204 (e.g., it may communicate 203 with the electronic device 202 over a network, such as the Internet) or it may be disposed locally or within a nearby area with the setting 204 in alternative embodiments. The system or component 201 includes, or is capable of communicating with, a memory that is configured to store a variety of information or data about possible customizations that may be selected amongst by a user. For example, these customizations may be wallpaper designs, paint colors, decorative items, items of furniture that may be placed within the setting 204, or any of a variety of possible items or other characteristics for the setting 204. A user may then interface with the electronic device 202 (e.g., via software running on the electronic device 202 to choose among those available customizations). This user interfacing may be via selection of a user interface element (e.g., a dropdown box) that is displayed upon the display 226 of the electronic device 202, the same as or similar to previous discussions. In an alternative embodiment, this user interfacing may utilize voice recognition for determining user desires, the same as or similar to previous discussions.

In this fashion, upon the electronic device 202 receiving user input and communicating 203 such input to the system or component 201, the display 226 of the electronic device may be updated accordingly with such desired customization information. One example could include the user pointing the electronic device 202 at the second wall 212 and indicating that they would prefer if the second furnishing 222 was a mirror (e.g., in place of a painting). The system or component 201 may communicate 203 a number of possible customizations (e.g., different mirrors) to the electronic device 202 for the user to select amongst. In an alternative embodiment, the customizations may be stored directly upon the electronic device 202 such that no communication 203 with an additional system or component 201 is needed.

Upon finalizing a selected customization, the display 226 of the electronic device 202 displays the chosen customization in the desired location of the setting 204 (e.g., “erases” or “draws over” the second furnishing 222 with the chosen customization). In certain embodiments, the physical setting 204 may be provided without any furnishings such that it is a bare unit that becomes customized with furnishings only via the display screen 226. In this fashion, the user has augmented the physical setting 204 with virtual items that are displayed via the display 226 of the electronic device 202.

Any or all of the aspects of the setting 204 may be customizable in the same or similar fashion (e.g., the first wall 210 and/or the first furnishing 220, the second wall 212 and/or the second furnishing 222, the floor 214, the first item of furniture 224, etc.). A user may be permitted to particularly customize discrete aspects of the setting 204 (e.g., “turn this specific wall a red color”) or may customize many aspects of the setting 204 all at once (e.g., “make this room hacienda style,” which may modify multiple items of furniture, wall colors, wallpaper patterns, lighting, and/or other decorations or aspects for display upon an electronic device at once). Upon the electronic device 202 being oriented or positioned by the user at a particular area of the setting 204, image recognition of the setting 204 may be employed to determine those areas and/or furnishings currently being displayed upon the display 226 of the electronic device 202 and modified accordingly, per user input.

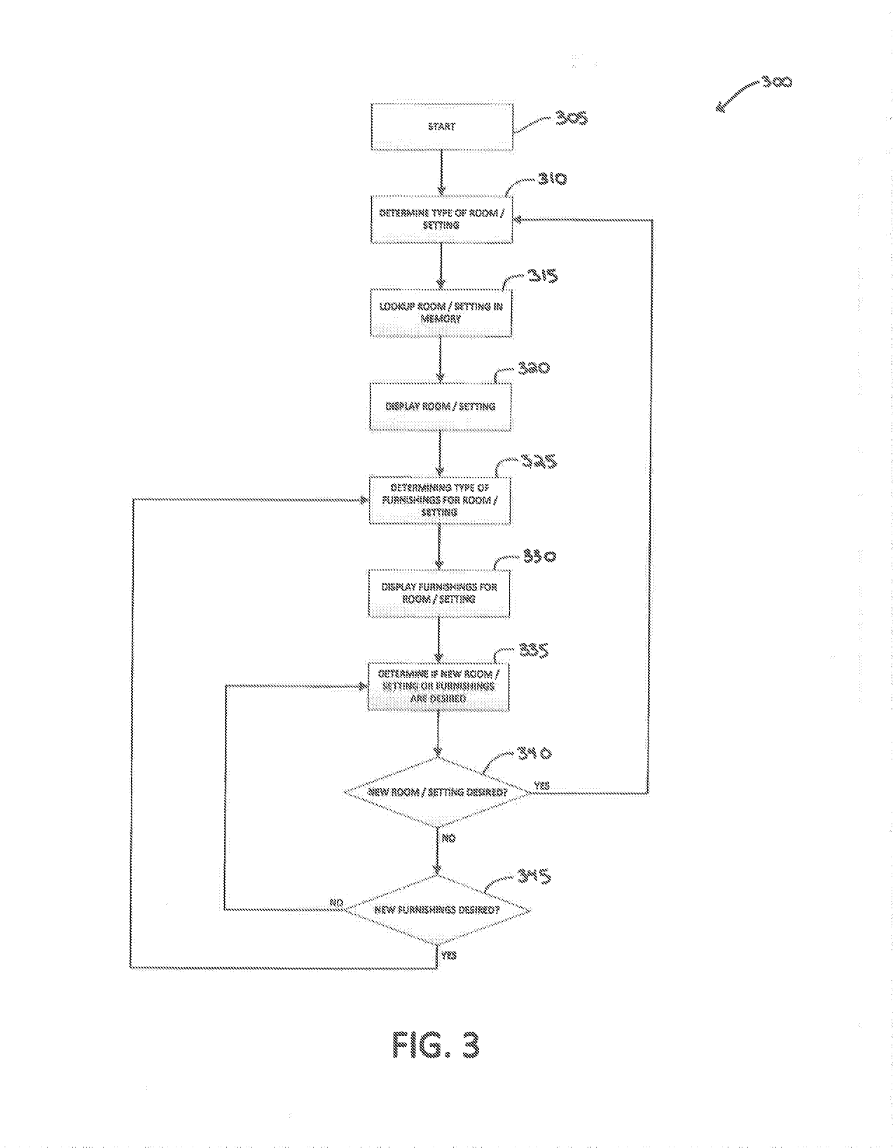

FIG. 3 shows a flowchart 300 for implementing a customizable virtual reality real estate property viewing system. Certain features and/or operation of one or more steps described for the flowchart 300 may be the same as or similar to those previously discussed. As shown, operation begins at step 305. This may occur, for example, when a user puts on a hardware component (such as headgear 102 or similar hardware) and loads a software application from a system or device connected with the hardware component (such as a software application configured to generate and/or display one or more real estate settings with customizable characteristics and/or furnishings).

Operation continues to step 310 where the system or software application implementing the flowchart determines a type of room and/or setting for display to the user. This determination may be determined via any of a variety of possible ways. For example, the same as or similar to previous discussions, a user interface element, such as a text box, drop down box, etc. may be interfaceable with by the user for selection of a particular home, property, room, etc. In another example, voice recognition may be incorporated for determining the particular home, property, room, etc. (e.g., via prompted and/or unprompted spoken words from the user).

The same or similar to previous discussions, and as discussed further below, such operation may allow a user to tour a home or property and/or customize those rooms or areas of a property during the tour. Voice recognition and/or other user interface elements may allow a user to quickly travel from one place within a unit to another or across multiple units. Like previously discussed, if a user is most interested in what the master bedroom looks like for a home they are touring, the user may state (either independently, or in response to a prompt from the system, such as via a virtual agent or avatar) that they wish to see the master bedroom, which then may cause the system to be immediately loaded for the user.

In certain embodiments, the user may be able to immediately switch among different units (e.g., load a completely different home or property for viewing from the one they were presently within), travel outside the unit (e.g., see a surrounding neighborhood for the home), and/or any of a variety of travel options, either upon their own movement using a user interface or control element, via prompted or unprompted voice commands, and/or other user interface manipulation. In certain embodiments, the user may be able to tour any of a variety of geographically settings around the home and/or those areas that are not in immediate vicinity of the home (e.g., users can tour any of a local property, a local community of a particular property, and/or other communities—either locally or in other cities or geographic locations).

During this touring operation, at step 315, the system or software application implementing the flowchart may be capable of looking up or otherwise obtaining data or information corresponding to such input. For example, the system may be located remotely or include remotely connected components (e.g., memory) that are in communication with the headgear. In other embodiments, the components (e.g., memory) may be entirely local. Thus, in either embodiment, data or other information can be looked up in such memory and communicated to the headgear for display. At step 320, this home, property, room, or any other setting is displayed to the user via the headgear or other hardware component. The user may then be allowed to view, walk around, or otherwise interact with the displayed setting, for example, the same as or similar to previous discussions, such as for FIGS. 1 and/or 2.

At step 325, the home, property, room, or other setting may be further customized by or for the user. Furnishings and/or other characteristics of the displayed setting may be determined, for example, in the same or similar fashion as previously discussed for step 310 (e.g., user interfaceable elements, voice recognition, etc.). In this fashion, not only can a user select a desired setting for viewing, but can also customize any of a variety of components or furnishings for such setting, such as color, wallpaper, furniture, appliances, flooring types, lighting types, decorations, etc. In certain embodiments, many furnishings may be customized for the user at once (e.g., the system may determine that a user prefers a “hacienda” style home and accordingly update one or many furnishings to match such a style). Certain embodiments may allow a user more discrete customizations (e.g., the system may determine that a user prefers to change just the kitchen table to a different table than the one currently displayed). After determining one or more furnishings that the user wishes to customize, operation continues to step 330 where display of the corresponding furnishings are added, removed, or otherwise modified or customized in accordance with the user's desires, the same as or similar to the display of step 320.

Operation then continues to step 335 where the system determines if a new or home, property, room, other setting, etc. and/or furnishing is desired. This determination may be the same as or similar to those previously discussed (e.g., at steps 310 and/or 325). If, at step 340, a new home, property, room, other setting, etc. is desired, operation continues to step 310 where further determination as to the desired type is performed, the same as or similar to previous discussions. If, at step 340, no new home, property, room, other setting, etc. is desired, operation continues to step 345. At step 345, if new furnishings for the current home, property, room, other setting, etc. is desired, operation continues back to step 325 where further determination is made as to the desired type, the same as or similar to previous discussions. If no new furnishings are desired, operation continues back to step 335. Thus, the system may remain in such loop to allow a user to walk through and/or examine the home and customize various features and/or visit new areas as desired, until the user wishes to end the walk-through (e.g., by taking off the headgear or other hardware and/or interfacing with a user interface element or via voice recognition to end the session).

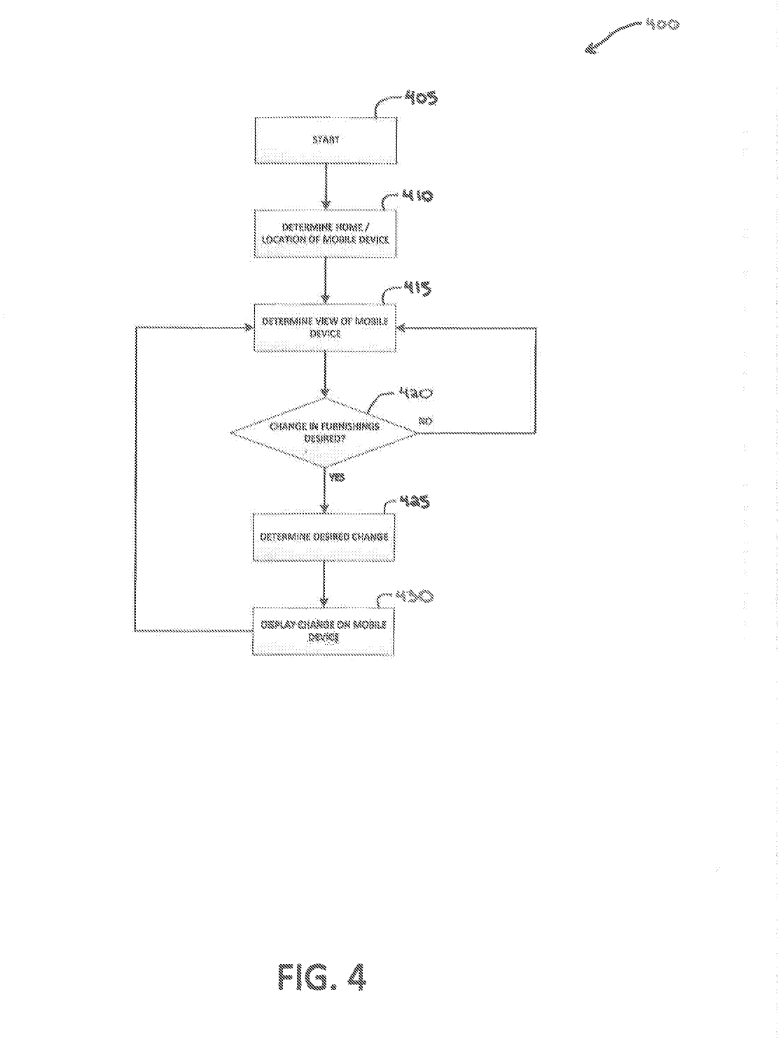

FIG. 4 shows a flowchart 400 for implementing a customizable augmented reality real estate property viewing system. Certain features and/or operation of one or more steps described for the flowchart 400 may be the same as or similar to those previously discussed. As shown, operation begins at step 405. This may occur, for example, when a user executes or otherwise begins use of a software application by an electronic device (such as a smartphone, wearable, etc.). This software application may communicate (e.g., wirelessly via the Internet or other network) with a remote system having data or information stored therein, as discussed in greater detail below.

At step 410, the software application that includes one or more features described as part of the flowchart 400 determines the home or other location of the electronic device (e.g., mobile device such as a smartphone) that is executing the software application. In certain embodiments, such determination may involve the use of outside systems and/or elements (e.g., GPS) that help pinpoint the location of the mobile device. In still other embodiments, user input may be used to determine the location of the mobile device (e.g., the user or other operator may input an address or other indicia of the home, property, setting, etc. where presently located or where the augmented reality functionality is to be employed).

At step 415, the software application determines the current view or vantage point of the mobile device. This may, for example, utilize a camera of the mobile device (e.g., image recognition) and/or other sensors of the mobile device (e.g., accelerometers, gyros, etc.). This determination of the current view and/or identification of objects within a view (e.g., using a camera of the mobile device) may be the same as or similar to previous discussions, for example, as discussed for FIG. 2.

At step 420, the software application determines whether there is a change in furnishings (e.g., wallpaper, color, furniture, decorations, etc.) desired for the particular room, property, setting, etc. where the mobile device is currently located and/or viewing on its display. Such determination may involve user input (e.g., via a user interface that is overlaid onto a display of the mobile device, the same as or similar to previous discussions, via voice recognition, the same as or similar to previous discussions) that indicates the user wishes to make some change in the environment or setting that is displayed upon the mobile device. If there is no change desired, operation continues back to step 415 where the view of the mobile device is determined. In this fashion, the software application continues to keep track of the current view or vantage point of the mobile device in order to effectuate desired customizations via furnishing changes.

If there is a change desired, operation continues to step 425 and the desired change in furnishings is determined. Determining the desired change may be performed by a variety of methods, for example, those that are the same as or similar to previous discussions. For example a user may audibly respond, speak commends, or otherwise interact with the software application to choose one or more furnishings for which customization is desired and/or indicate the desired customization (e.g., choose a particular wallpaper pattern, color, furniture option, etc. from a memory for inclusion into the displayed setting of the mobile device). At step 430, the desired customization or change of step 425 is performed and/or displayed upon a display of the mobile device. For example, if a physical countertop at the location of the mobile device is being displayed upon a display of the mobile device (e.g., via pointing of a camera of the mobile device at the countertop), but the user prefers to see what the countertop would look like were it made of a different material, such as granite in place of wood, the user may input this desired change and the display of the mobile device would update or replace the image of the countertop on the display with a modified image that replaces the wood portions of the countertop with granite. As previously discussed, any of a variety of such changes and/or modifications and/or additions on the display of the mobile device or other hardware may be performed in alternative embodiments.

The previously discussed system and/or mobile or software application may include features and/or operation different from those stated in the exemplary embodiments detailed above. Features and/or operation in one embodiment may also or additionally be included with features and/or operation of a separately discussed embodiment. Moreover, features may be added, removed, or executed with different operative flow from the exemplary embodiments detailed above.

In one example, in one embodiment and as mentioned previously mentioned, the system and/or software application may be configured to allow a user to register (e.g., create an account) therewith. Having such an account, various user properties and/or preference data may be stored and/or linked therewith, such that a user may store commonly-used customization criteria or other information (such as favorite styles or furniture). In one example, a user having a user account may be configured to receive notifications (e.g., pop-up notifications on a device running the software application, emails, text messages, etc.) based on stored criteria and/or past searches, such as when a new home or real estate property comes on the market that contains one or more matches for customization criteria previously used and/or set by the user.

In another example, in addition or alternatively to allowing a user to view and/or customize properties and/or locations, a user may be allowed to select and/or finalize a property selection. For example, a user may, when picking among available properties or locations (e.g., apartment units, homes, etc.) choose the various options and/or customizations, the same as or similar to previous discussions, and subsequently choose to finalize such options (e.g., save and/or display and/or print out a list of modifications, including parts or furniture needed, floor plans, etc.) so that such options and/or customizations can be physically incorporated into the property the unit is leasing or purchasing. In one embodiment, this may allow for customers of a home to modify the home and/or view such modifications using virtual reality, augmented reality, or some combination thereof to help decide on desired options, and then finalize such options so that a builder and/or manufacturer can physically incorporate those options into the property and/or provide pricing and/or equipment/furnishings needed to perform such options and/or customizations.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

What is claimed is:

1. A method of providing a customizable virtual setting for a potential customer of real estate, the method comprising the steps of:
providing a software application configured to be executed by a processor;
providing a database containing information corresponding to a plurality of customizations for selection by the customer;
displaying to the customer the customizable virtual setting via a screen;
determining, using the processor, a desired customization by the customer based upon at least one of the plurality of customizations; and
displaying the desired customization in the customizable virtual setting based on at least some of the information stored in the database.

2. The method of claim 1 wherein the determining of the desired customization by the customer includes the use of voice recognition.

3. A method of providing a customizable augmented setting for a potential customer of real estate, the method comprising the steps of:
providing a software application configured to be executed by a processor of a mobile device;
providing a database containing information corresponding to a plurality of customizations for selection by the customer, the database in communication with the processor;
displaying to the customer the customizable augmented setting via a screen of the mobile device using a camera of the mobile device;
determining, using the processor, a desired customization by the customer based upon at least one of the plurality of customizations; and
displaying the desired customization in the customizable augmented setting via the screen of the mobile device based on at least some of the information stored in the database and image recognition of at least a portion of the customizable augmented setting displayed via the screen of the mobile device.

4. The method of claim 3 wherein the determining of the desired customization by the customer includes the use of voice recognition.
